(19) United States
(12) Patent Application Publication
(10) Pub. No.: US 2005/0105600 A1
(43) Pub. Date: May 19, 2005

(54) System and method for location tracking using wireless networks

(75) Inventors: Dragoslav Culum, Ottawa (CA); Vincent Ng, Ottawa (CA); Roshdy H.M. Hafez, Ottawa (CA)

Correspondence Address: FREEDMAN & ASSOCIATES, 117 CENTREPOINTE DRIVE, SUITE 350, NEPEAN, ONTARIO, K2G 5X3, CA

(73) Assignee: Okulus Networks Inc., Ottawa (CA)

(21) Appl. No.: 10/986,989

(22) Filed: Nov. 15, 2004

Related U.S. Application Data
(60) Provisional application No. 60/519,650, filed on Nov. 14, 2003.

(51) Int. Cl. H04B 1/69

(52) U.S. Cl. 375/150

(57) ABSTRACT

A novel wireless tracking system is disclosed for determining a location of an 802.xx compatible mobile tag or other 802.xx compatible wireless device located within the wireless tracking system. The mobile tag or wireless device communicates with the wireless tracking system using data packets in accordance with predetermined wireless protocols. A plurality of location sensors receive the data packets and provide angle of arrival and intensity information to a wireless tracking system server which performs statistical processing on this information and determines the location of the mobile tag or other wireless device within the wireless tracking system.

This application claims the benefit of United States Provisional Application No. 60/519,650, filed Nov. 14, 2003.

### FIELD OF THE INVENTION

The invention relates to the field of wireless devices and more specifically to the field of location determination for a wireless device within a wireless network.

### BACKGROUND OF THE INVENTION

Item tracking in wireless systems is commonly used in a wide variety of stores and companies. For example, in U.S. Pat. No. 6,705,522B2 by Gershman et al. a mobile object tracking system is disclosed. This system relies upon providing electromagnetic radiation to a tag and then monitoring electromagnetic radiation provided from the tag. Such a system is useful in situations where the tag is in close proximity to the source of electromagnetic radiation such as a retail environment. In U.S. Pat. No. 6,369,710B1, Poticny et al. disclose a wireless security system that is used provide a signal to a mobile device when it is in close proximity to a hazard. This concept is speculated to be of use in ensuring that pets do not leave their owner's property. In U.S. Pat. No. 6,720,888 B2 by Eagleson et al, a tracking system for mobile devices using tags is disclosed. This prior art reference is clearly intended for inventory management applications. Eagleson teaches a system in which containers have radio frequency identification tags fixed to them.

Another set of prior art deals with locating a device based upon a tag located on the device. For example, some prior art references describe GPS security systems for cars that can provide a GPS signal to a station indicative of the position of the car. Still other prior art references, such as U.S. Pat. No. 6,456,239 by Werb et al. deal with methods of precisely locating tags using radio frequency technology in combination with a triangulation system.

Wireless computer networks provide workers access to company files from any supported area. This access gives worker flexibility, however, it can represent a security threat. Specifically, a computer is able to access a network from many locations that might not be ordinarily supported. Thus, for example, a malicious user of a wireless network need only gain access to a portable computer with wireless network access that is logged in to get unauthorized access to the network. Continuing with this example, if the malicious user steals the portable computer while it is logged in, then such a user could continue to operate the computer and access the network while in relatively close proximity to a company wireless access point. Alternatively, a malicious user optionally tries to gain access to the network while hacking it from a location that is sufficiently close to permit wireless communication with the wireless access point. Thus, a malicious user in a company parking lot, or even in on a public sidewalk in a dense commercial area could gain unauthorized access to a company network. In U.S. patent application 2002/0094777 A1 by Cannon et al. this problem is addressed by providing globlal positioning system (GPS) receivers on various network devices and requesting GPS information from a wireless device when it accesses the wireless network. As GPS devices are not typically provided with wireless computers, implementing the system of Cannon et al. would likely represent a substantial cost to the administration of the wireless network. Additionally, a malicious user could modify their computer to provide false GPS data to the network when they choose to access it. Additionally, GPS signals do not always propagate properly in urban environments and, consequently, multipath often confuses the receivers resulting in incorrect position information. Such an incorrect result could cause an authorized user in an authorized location to be denied access to the network resulting in frustration and lost productivity.

It would be beneficial to provide a wireless network that supports wireless access to associated computing devices within a precisely predetermined region absent a need to provide additional hardware to the associated computing devices. Additionally, it would be beneficial to have a wireless network that supports both the tracking of associated computing devices and inexpensive mobile tags used to track important items within a workspace.

### SUMMARY OF THE INVENTION

In accordance with the invention there is provided a method for estimating a location of one of a plurality of wireless devices that transmit a plurality of data packets within a wireless tracking system: providing a plurality of location sensors comprising a plurality of antenna elements; receiving the plurality of data packets using the plurality of antenna elements, each data packet in accordance with a known data transmission protocol for use in wireless data communication, where each of the plurality of antenna elements receives the plurality of data packets with a different delay time therebetween; determining an angle of arrival at each location sensor from the plurality of location sensors in dependence upon the different delay time between the received data packets to form a plurality of angles of arrival; measuring at each of the plurality of antenna elements an intensity of the received plurality of data packets to form a plurality of intensities; providing of the plurality of angles of arrival and the plurality of intensities to a wireless tracking system server; estimating a location of the wireless device within the wireless tracking system in dependence upon the plurality of angles of arrival and the plurality of intensities from each of the plurality of location sensors using the wireless tracking system server.

The invention teaches a method for estimating a location of one of a plurality of wireless devices that transmit a plurality of data packets within a wireless tracking system comprising: providing a plurality of location sensors comprising a plurality of antenna elements; receiving the plurality of data packets using the plurality of antenna elements, each data packet in accordance with a data transmission protocol for use in wireless data communication, where each of the plurality of antenna elements receives the plurality of data packets with a different delay time therebetween; determining an angle of arrival at each location sensor from the plurality of location sensors in dependence upon the different delay time between the received data packets to form a plurality of angles of arrival; measuring at each of the plurality of antenna elements an intensity of the received plurality of data packets to form a plurality of intensities; providing the plurality of angles of arrival and the plurality of intensities to a wireless tracking system server; and, estimating a location of the wireless device within the wireless tracking system in dependence upon the plurality of angles of arrival and the plurality of intensities from each of the plurality of location sensors using the wireless tracking system server.

In accordance with the invention there is provided a system for using a wireless network supporting 802.xx wireless communication protocols comprising: a plurality of mobile tags for communicating with the wireless tracking system using data transmission signals and for receiving data from the wireless network in accordance with the wireless communication protocols; a plurality of location sensors spatially disposed from one another, each location sensor comprising a plurality of antenna elements for passively receiving the data transmission signals transmitted from the mobile tag and in accordance with a known data transmission protocol for wireless data communication and a processor for determining a time difference of arrival between the plurality of antenna elements and for in dependence upon the determined time difference of arrival calculating an angle of arrival of said data transmission signals from the mobile tag and for determining an intensity of said data transmission signals; and, a central processing system for receiving the angle of arrival and the intensity of said data transmission signals for each of the plurality of location sensors and for performing statistical calculations to estimate a physical location of the mobile tag in relation to the plurality of location sensors.

In accordance with the invention there is provided an 802.11 compatible receiver for use with a wireless tracking system comprising: a plurality of antenna elements for receiving 802.xx compatible wireless data communication signals according to a predetermined protocol; a processor for identifying a data packet within a signal and based on protocol data therein, for determining an angle of arrival of the data packet based on differences in signal received at each of the plurality of antenna elements and for determining an intensity of the signal including the data packet; and, a transmitter for transmitting the angle of arrival and the determined intensity of the signal to a wireless tracking system.

In accordance with the invention there is provided a mobile tag comprising: a piezo sensor for sensing a movement of the mobile tag; and, a wireless transmitter for transmitting data relating to an identification of the mobile tag to a location sensor in accordance with wireless communication protocols upon the piezo sensor sensing movement of the mobile tag.

### BRIEF DESCRIPTION OF THE DRAWINGS

Exemplary embodiments of the invention will now be described in conjunction with the following drawings, in which:

FIG. 1 illustrates a typical prior art wireless network;

FIG. 2 illustrates a first embodiment of the invention, a wireless tracking system (WTS);

FIG. 3a illustrates details of a mobile tag (MT);

FIG. 3b illustrates the MT for operating in two modes of operation, hibernation and transmission;

FIG. 4a illustrates a high level diagram of one of a plurality of location sensors (LSs);

FIG. 4b illustrates the front-end circuitry RF board of the LS;

FIG. 4c illustrates a single receiver chain in more detail, where four of these receiver chains are utilized within the LS receiver front-end circuitry RF board;

FIG. 5 illustrates the plurality of LSs through for receiving the RF signal from the MT;

FIG. 6a illustrates a WTS in accordance with a second embodiment of the invention;

FIG. 6b illustrates a specialized API for execution by the WTS server to allow it to interface with any number of application-specific systems or software programs;

FIG. 7 illustrates a high level diagram of single LS;

FIG. 8 illustrates a case where there is no existing 802.11x wireless network infrastructure that has an access point (AP) and the plurality of LSs are each adapted for operating as an AP for wireless devices within the network;

FIG. 9 illustrates the WTS for not only tracking of a MT but also for use in location determination of a wireless device, such as laptop computer having 802.11x wireless capabilities;

FIG. 10 is a flowchart describing an FPGA method;

FIG. 11 is a flowchart detailing operation of a WTS server;

FIG. 12 is a flow chart detailing an embodiment of operation following the triggering of a timer;

FIG. 13 is a flowchart showing a possible method for determining intersections;

FIG. 14 is a diagram of a floor plan with a series of lines with intersections of the lines corresponding to anticipated locations of wireless devices;

FIG. 15 is a flowchart consistent with a maximum density method;

FIG. 16 is a diagram of a floor plan showing likely locations of a wireless device;

FIG. 17 is a diagram showing possible transitions in location of a device;

FIG. 18 is a flowchart consistent with a Markov model;

FIG. 19 is a diagram consistent with a movement of a wireless device in an area monitored by a system according to an embodiment of the invention; and,

FIG. 20 is chart showing a switching between train states and operation states of the Markov model.

### DETAILED DESCRIPTION THE EMBODIMENTS OF THE INVENTION

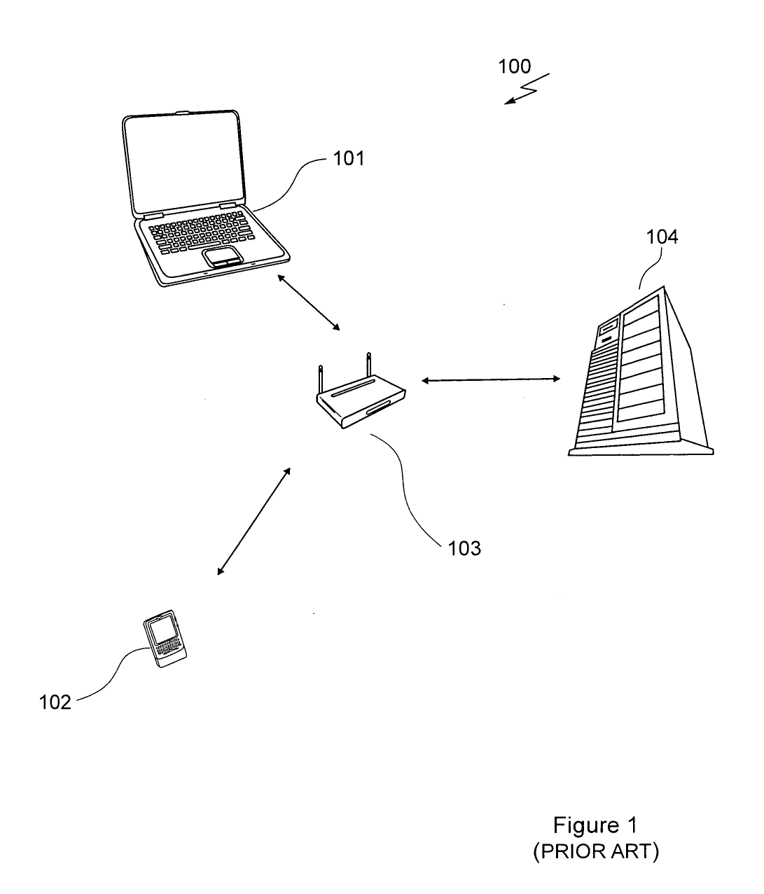

FIG. 1 illustrates a typical prior art wireless network 100. The wireless network includes a first wireless device 101 and a second wireless device 102 for wirelessly communicating with an access point (AP) 103 in the form of a wireless hub, or router. The wireless hub 103 is for facilitating communication between the first and second wireless devices 101 and 102 and the Internet via a server 104. In this typical wireless network, IEEE 802.11x communication protocols, as are well known to those of skill in the art, are employed in order to wirelessly exchange data within the wireless network 100. 802.11x protocols encompass 802.11, 802.11a, b or g as well as similar WLAN standards.

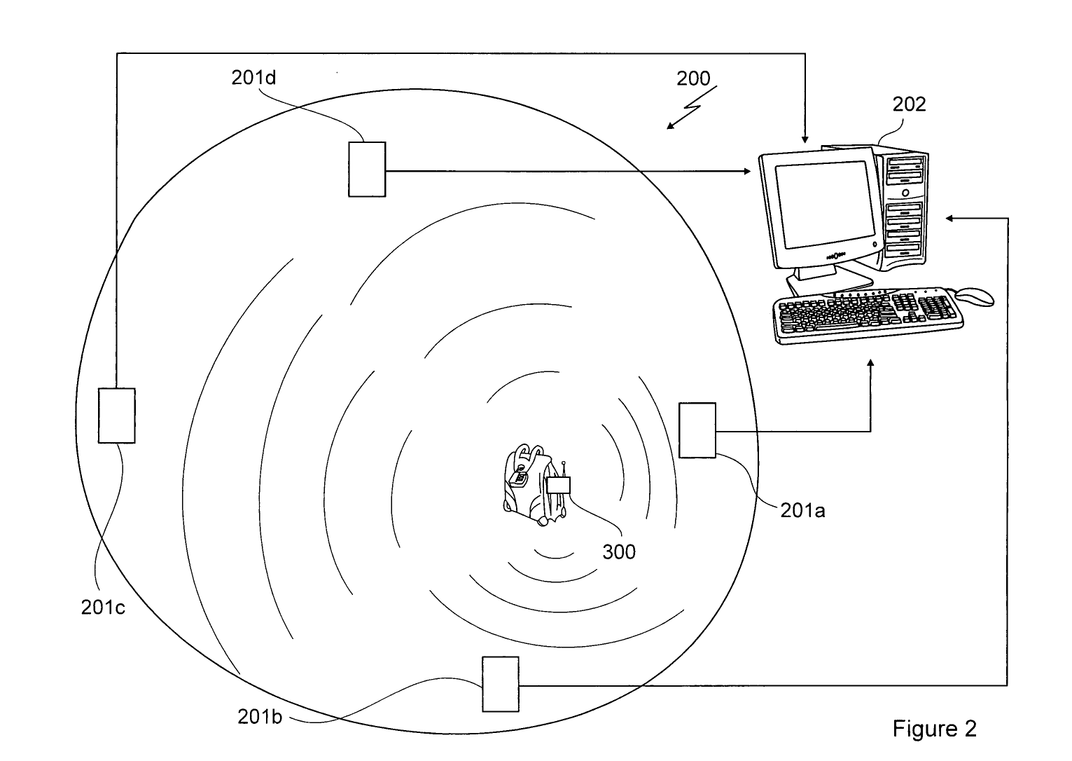

FIG. 2 illustrates a first embodiment of the invention, a wireless tracking system (WTS) 200. The WTS 200 includes a plurality of location sensors (LSs) 201a through 201d connected to a WTS server 202. The plurality of LSs 201a through 201d are unsynchronized to each other and in this embodiment of the invention primarily function as passive listening stations that are used in performing independent location triangulation calculations using angle of arrival (AOA). The plurality of LSs 201a through 201d are connected to the WTS server 202 and in conjunction therewith are used for determining a location of a mobile tag (MT) 300 located at some point within the WTS 200. For the embodiments of the invention described herein, 802.11x protocols encompass 802.11, 802.11a, b or g, as well as similar wireless local area network (WLAN) standards.

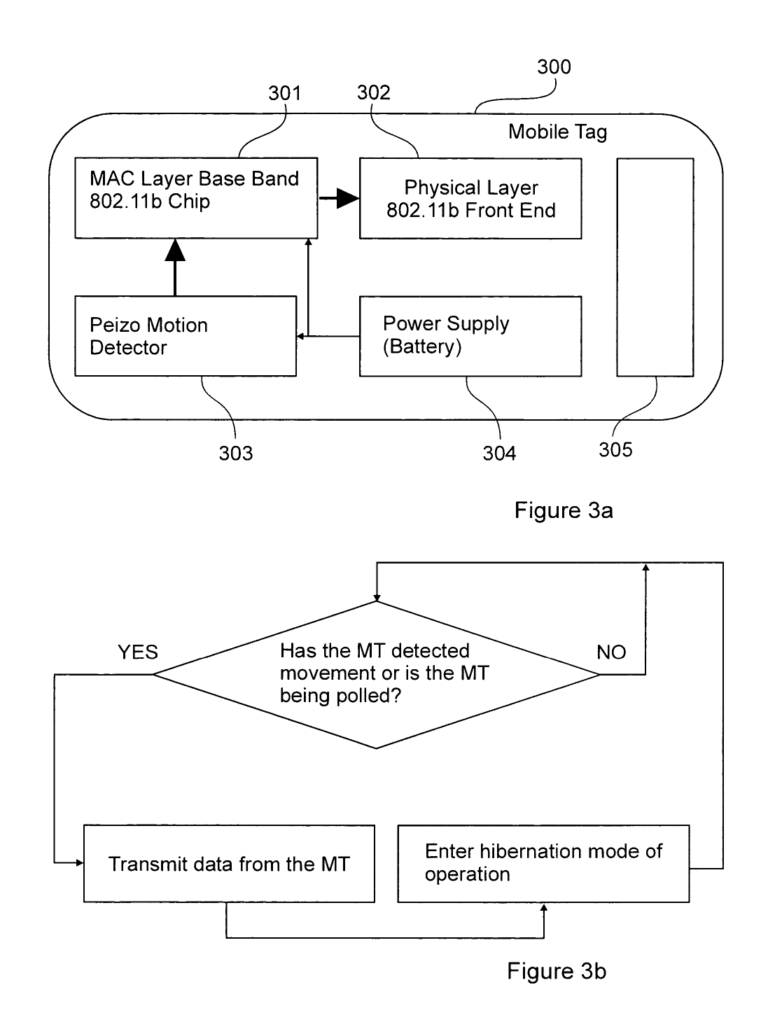

FIG. 3a illustrates the MT 300 in detail. The MT 300 is preferably an 802.11x network device that utilizes an off-the-shelf 802.11x chipset, that includes a MAC layer base band 802.11x chip 301 and a physical layer 802.11x front end 302 with a piezo sensor 303 and an internal power source 304. Preferably the MT 300 is enclosed inside a plastic enclosure with application-specific attachment mechanism. The MT is for being attached to articles or personnel that are to be tracked within the WTS 200.

The MT 300 relies on the internal power source 304 to function as an 802.11x device. Referring to FIG. 3b, the MT 300 operates in two modes of operation, hibernation and transmission, where the MT 300 enters the hibernates mode of operation when it is not being polled within the WTS 200 or is not being moved within the WTS 200 for a programmable amount of time. The embedded piezo sensor 303 is used for detecting of a mechanical shock and reawakens the MT 300 from the hibernation mode of operation to the transmission mode of operation. In the transmission mode of operation, the MT transmits its information to the WTS 200. In the hibernation mode of operation, the MT 300 operates with sufficient functionality to detect when it is being polled within the WTS 200, or is simply turned off for a preprogrammed amount of time. When polled by the WTS 200, the MT 300 responds by transmitting data stored within its internal memory 305 or transmits other data in compliance with protocols utilized within the WTS 200.

Preferably, the internal power supply 304 is of the button/coin cell type, and is replaceable after its useful lifetime. The MT is preferably compliant in accordance with IEEE 802.11x standards. Preferably, with the two modes of operation, the MT 300 offers a battery life of 3-5 years and preferably operates at 3.3V.

In response to the MT 300 being polled within the WTS 200, the MT 300 imitates operating in a poll/response mode of operation. In the poll/response mode of operation MT 300 responds using the following in dependence upon preprogrammed conditions: if no additional data is stored in the internal memory 305, the MT responds according to 802.11x MAC protocol rules. If additional data is stored within the internal memory 305 a burst transmission is transmitted within the WTS 200 to the WTS server 202. Upon completion of one of these actions, the MT 300 enters the hibernation mode of operation.

A motion detected mode of operation is initiated when the MT 300 is currently operating in the hibernation mode of operation and it receives a mechanical shock exceeding a preprogrammed threshold. The embedded piezo sensor 303 initializes the motion detected mode of operation by sending the appropriate interrupt/trigger signal to the MAC chip 301. The MT 300 then transmits a predefined packet of information according to the following conditions: if additional data is stored within the internal memory 305, a burst transmission of this data is broadcast within the WTS 200, otherwise if no additional data is stored in the internal memory 305, the MT 300 transmits a null packet in accordance to WTS 200 protocol specifications.

Preferably, the MT 300 is field-programmable. The programming mode operation requires no special provision from the MT 300. When programming the MT 300, the WTS 200 polls the MT 300, and the identification information of the personnel or article to which the mobile tag is attached are entered at the WTS server 202. This process is optionally integrated with a barcode/SKU scanning procedure or a WMS interface. During the programming mode operation, the relevant UPC/SKU information related to the item being tagged can be sourced from an integrated WMS/ERP database and relayed securely to the MT 300 as encrypted data. Referring back to FIG. 2, the MT 300 transmits a wireless signal within the WTS during a motion detected mode of operation and during the poll response mode of operation. This wireless signal is then received by each of the LS 201a through 201d. A person of skill in the art will appreciate that a variety of other types of mobile tags supporting 802.11x and MAC addresses are optionally used with the system of FIG. 2. For example, an alternative mobile tag features a micro electromechanical systems (MEMS) switch that functions as a shock sensor instead of an embedded piezo sensor. Another alternative mobile tag design features a larger power source and a passive RF sensor instead of a mechanical shock sensor. This mobile tag responds to a predetermined RF ping signal. Optionally, the RF ping signal is provided via the wireless network.

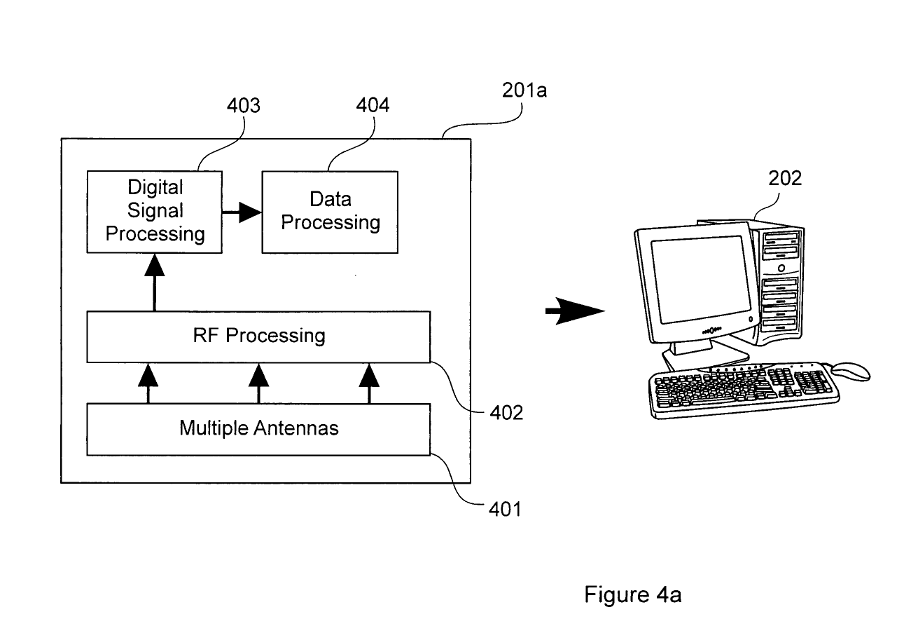

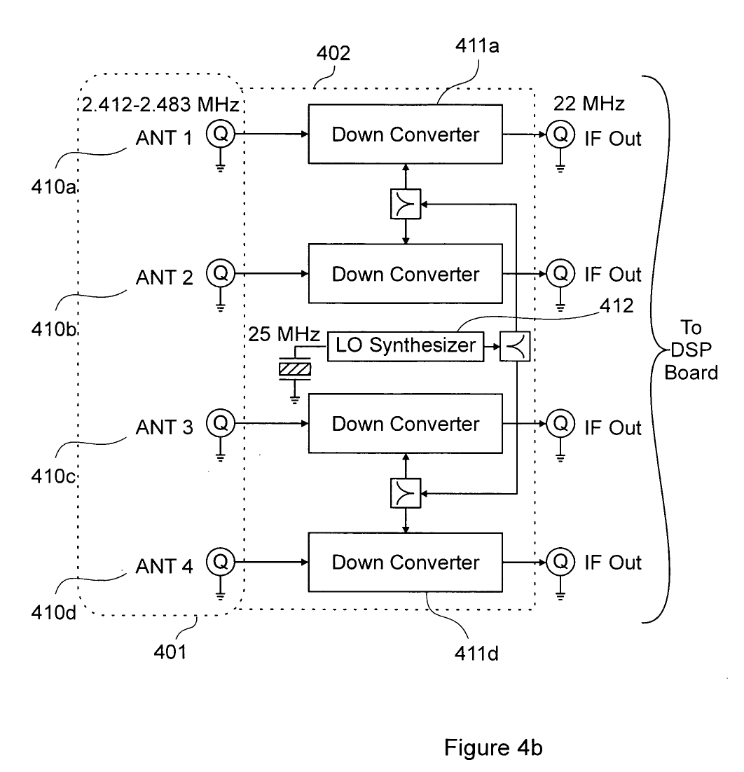

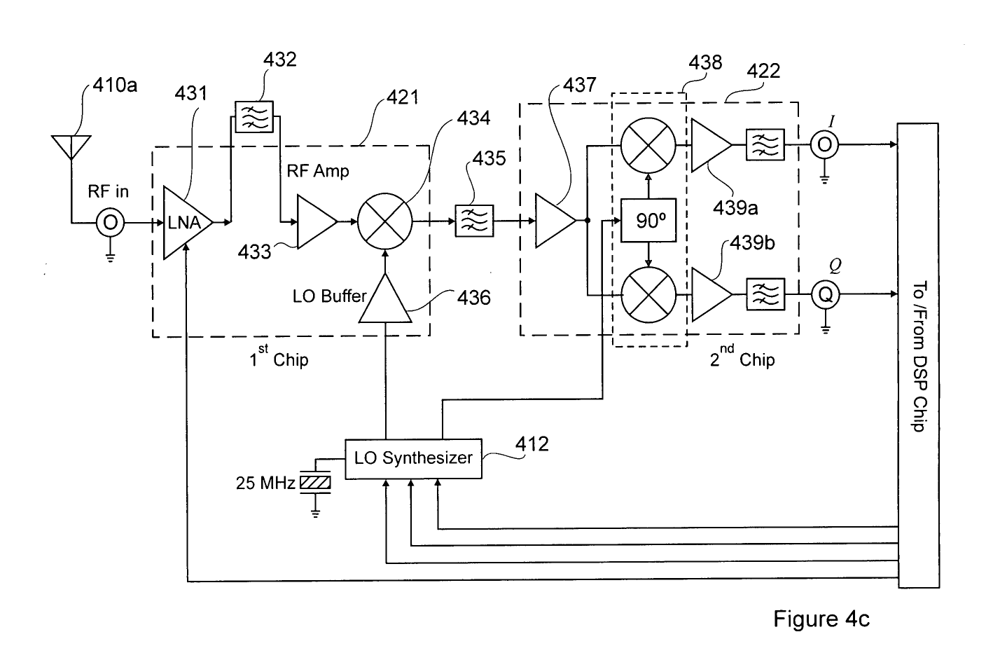

FIG. 4a illustrates a high level diagram of one of the plurality of LSs 201a through 201d, for example LS 201a. Disposed within the LS 201a is an array of RF antennas 401, RF processing circuitry 402, digital signal processing (DSP) circuitry 403, and data processing circuitry 404 for communicating with the WTS server 202. FIGS. 4b and 4c illustrate the LS 201a in more detail.

FIG. 4b illustrates the front-end circuitry RF board, 401 and 402, of the LS 201a. This circuitry provides a direct conversion subsystem, with zero IF, that converts the 802.11x signals, which are between 2.412-2.483 GHz, to I/Q baseband signals for processing by the DSP 403. The RF board, 402, includes four receiver chains in parallel. RF signals are received by each of the four RF antennas, 410a through 410d. Disposed within each receiver chain, between the RF antenna and an output port thereof, is a corresponding down converter circuit 411a through 411d. Each of the four receiver chains obtain their LO signals from a common LO frequency synthesizer 412 in order to ensure substantially and identical performance for all of the receiver chains. Four output ports 413a through 413d provide the IF output signals to the DSP 413.

FIG. 4c illustrates a single receiver chain in more detail, where four, or more, of these receiver chains are utilized within the LS receiver front-end circuitry RF board, 401 and 402. The receiver front-end in this design provides a direct conversion from radio frequencies at 2.412-2.484 GHz to I/Q baseband signals. This conversion is achieved by using two chipsets. The first chip 421 is a 2.4 GHz RF converter which converts the received RF signal from the RF antenna 410a to an IF signal at 374 MHz. The first chip includes a low noise amplifier (LNA) 431 with an input port connected to the RF antenna 410a, a RF amplifier 433, a RF mixer 434, and a LO buffer amplifier 436. The off-chip synthesizer 412 provides the LO signal to the LO buffer 436. An off-chip bandpass filter 432 is disposed between the LNA 431 and the RF amplifier 433 to improve out-of-band signal rejection for the RF front end, 401 and 402. An IF output signal propagated from an output port of the first chip 421, where this output port is connected to an off-chip IF filter 435 to attenuate the out-off-band signals and to improve image rejection. An output port of the off-chip IF filter 435 is connected to a second chip 422, which includes a variable gain control amplifier 437, a quadrature demodulator 438, and first and second I/Q baseband amplifiers, 439a and 439b. The output ports from the second chip 422 provide the I/Q baseband signals that are connected to input ports of the DSP 403 for further processing thereof. An alternative to this design is to perform a direct down-conversion using a single chip solution, which converts the received RF signal from the RF antennas to a baseband I/Q signal, or similarly- perform a direct down-conversion using a single chip solution to IF, and compute I/Q signal digitally in a DSP processor.

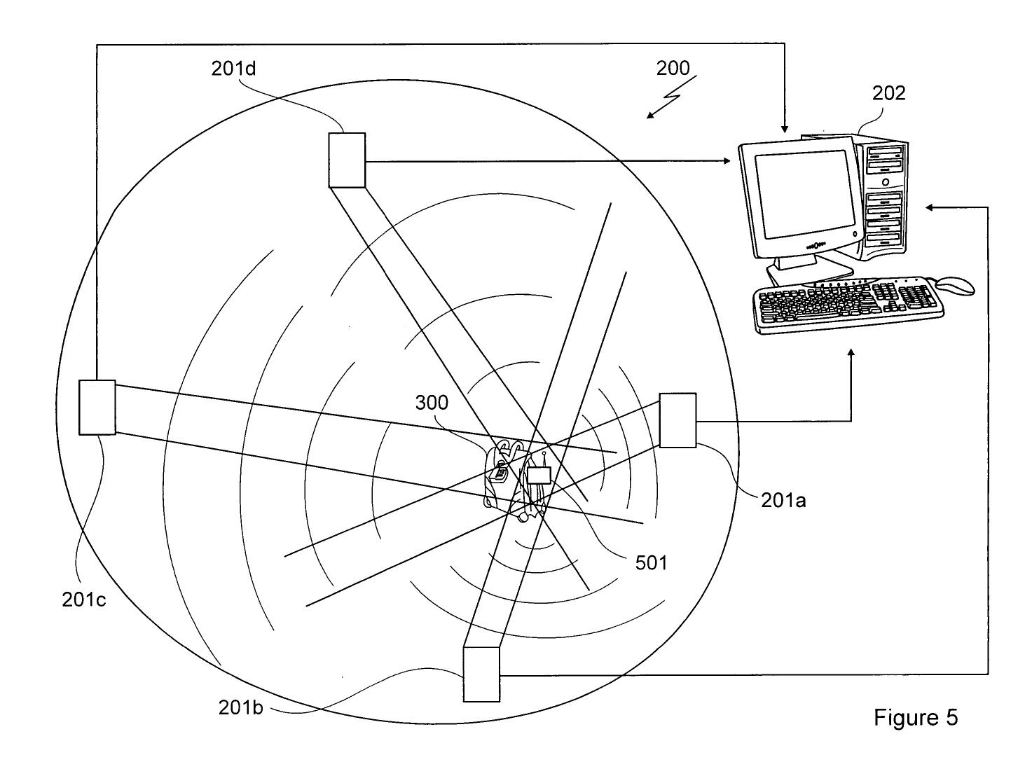

Referring to FIG. 5, each LS from the plurality of LS 201a through 201d, receives the RF signal from the MT 300, as shown. Referring back to FIG. 4b, because each LS has four, or more, antennas, 410a through 410d, up to three angles as well as up to three corresponding signal intensity amplitudes are computed by the DSP 403 for the RF signal received by each LS, 201a through 201d. Thereafter, each LS, 201a through 201d, provides this information to the WTS server 202 where the WTS server 202 executes a triangulation method from the angles and amplitudes received from each LS. Using statistical computation on up to twelve received angles and up to twelve received amplitudes, the WTS server 202 performs an estimation operation as to a location 501 of the MT 300 within the WTS 200. As shown in FIG. 5, the location of the MT 300 is approximately represented within the area denoted by 501. Advantageously, synchronization of the plurality of LSs, 201a through 201d, is not necessary, and the accuracy of obtaining position information for the MT 300 is improved by increasing the number of LS, 201a through 201d, within the WTS 200.

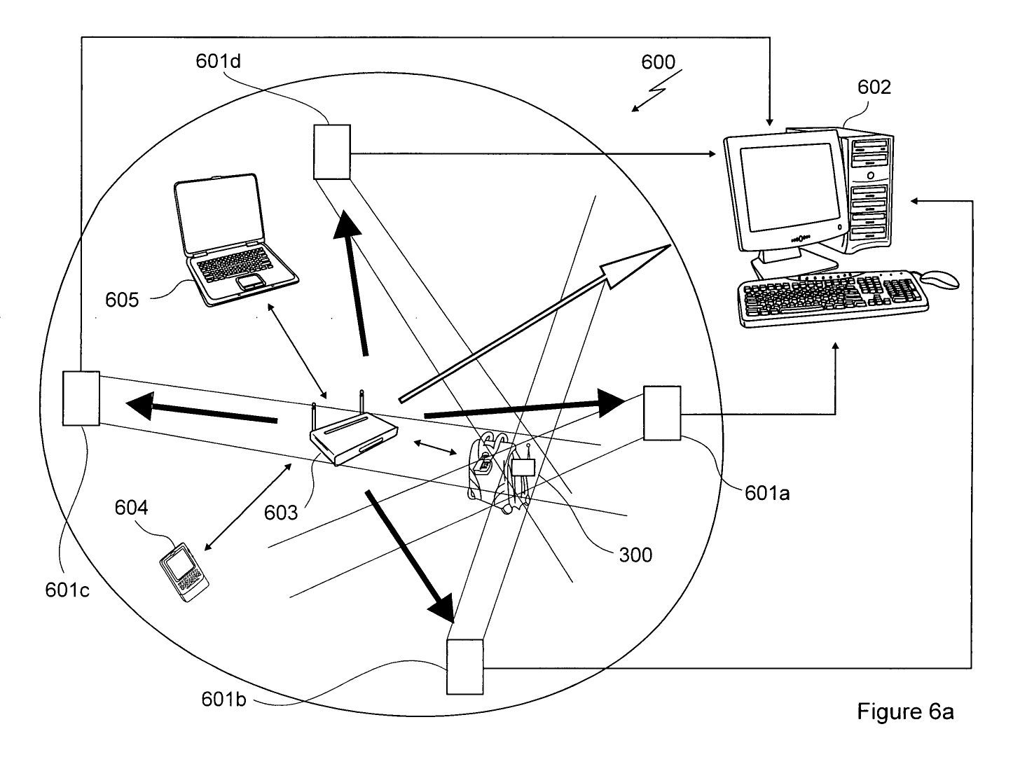

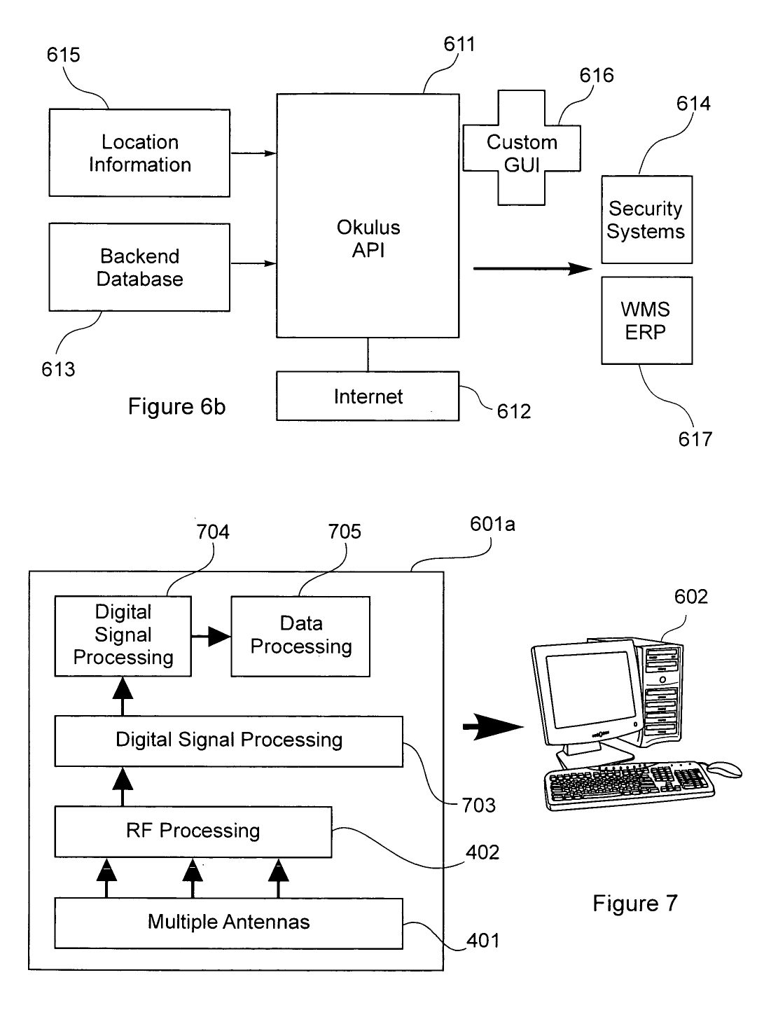

A person of skill in the art will appreciate that for the purposes of providing secure communication between a wireless network and a portable computing device associated with that network it is inherently insecure to use a first wireless connection to confirm the position of the device and a second wireless connection to provide data transfer. In other words, it would not be rational to provide a wireless tag on a portable computer to verify the position of the computer when it uses the wireless network absent some method of ensuring that the tag is in very close proximity to the portable computing device. Additionally, fixing tags to computers represents an additional cost to the wireless network and the administration of the network. In the second embodiment of the invention described with reference to FIG. 6a, the wireless network monitors the origin of a wireless signal intended for communication with the wireless network. If the origin of the signal corresponds to an unauthorized area then a lower security level is provided than a same signal provided from an authorized area. Optionally, the wireless network rejects attempts at communication by any wireless computing device that is outside an authorized area.

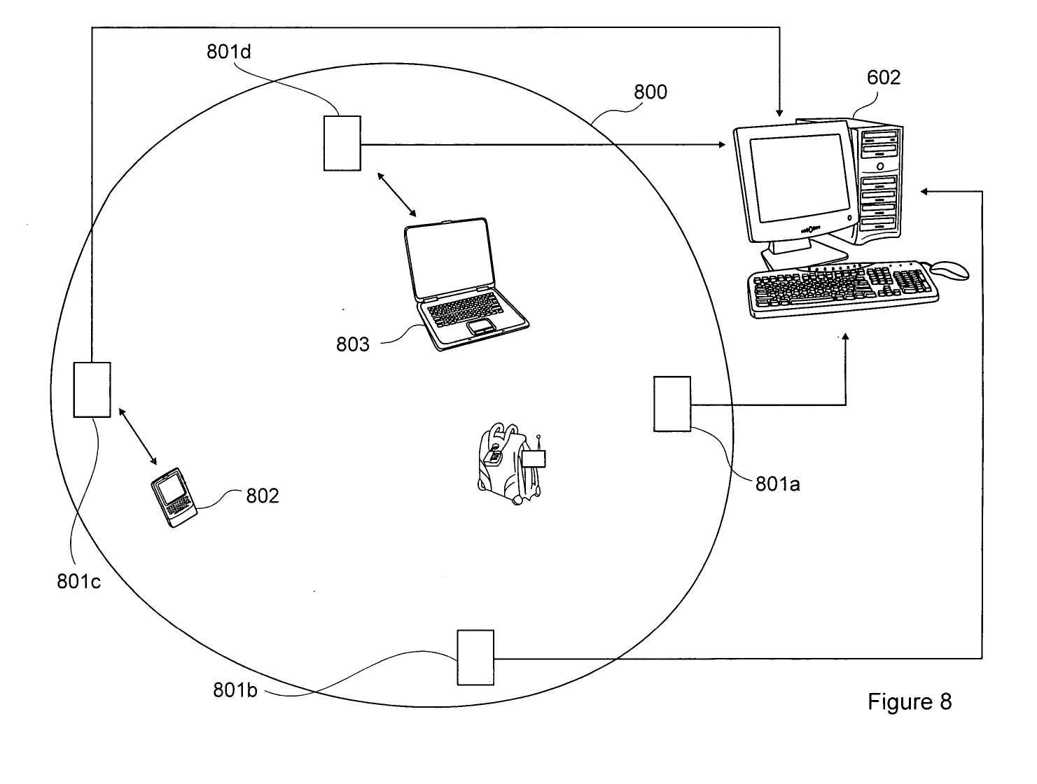

FIG. 6a illustrates a WTS 600 in accordance with a second embodiment of the invention. In this embodiment, a plurality of LSs, 601a through 601d, are disposed for wirelessly communicating with the WTS server 602 using an access point 603. A conventional wireless network, such as that shown in prior art FIG. 1, is used with the WTS 600. The wireless network includes a first wireless device 604 and a second wireless device 605 for communicating with an access point (AP) 604 in the form of a wireless hub. The AP 604 is for facilitating communication between the first and second wireless devices, 604 and 605, and the WTS server 602. Of course, the WTS 600 is not only for determining the position of the MT 300 but also for any other wireless device 604 and 605 (FIG. 8) compliant with protocols of the WTS 600.

The WTS 600 preferably utilizes the IEEE 802.11x protocol operating at the unlicensed 2.4 GHz band for 2 way communications between the MT 300, wireless devices 604, the plurality of LSs, 201a through 201d and the AP 603. The LSs, 201a through 201d, are wirelessly connected the AP 603 using existing WLAN channels and are recognized as standard network devices. The AP 603 is in turn networked to the WTS server 602 using Ethernet cables and function as the bridge between the wired and wireless networks. Optionally, the AP 603 is wirelessly connected to the WTS server 602.

In a typical wireless network, as shown in FIG. 1, 802.11x devices 101 and 102 communicate with the AP 103 using wireless signals in accordance with the 802.11x protocol. In the WTS 600 shown in FIG. 6, the plurality of LSs, 601a through 601d, passively receive these wireless signals. Based upon this communication, each LS from the plurality, 601a through 601d, computes the region from which the signal originated. Each LS from the plurality, 601a through 601d, then transmits the parameters of their calculated region, up to three angles and up to three signal intensities, to the AP 603 over the existing 802.11x WLAN. The AP 603 then provides this information to the WTS server 602 using the existing Ethernet connection or wireless LAN. From this provided information, the WTS server 602 calculates the intersection area of all of the possible regions from all of the plurality of LSs, 601a through 601d, using statistical processing. Thereafter, the WTS server 602 determines a location of a desired wireless device, 300, 604 or 605, within the WTS 600. Of course, the determination of the actual location of the wireless device, 604 or 605, or MT 300 is prone to error and the error is the difference between the actual location of the MT 300 or wireless device, 604 or 605, and the actual location within the WTS 600.

As is shown in FIG. 6b, the WTS server 602 additionally provides a specialized API 611 to allow it to interface with any number of application-specific systems or software programs, such as Internet access 612, database management systems 613 and security applications 614. This API 611 also provides the location tracking information 615 to the interfacing software on a query basis. The specialized API also presents this information on a display unit using a custom GUI 616 as part of the WTS server 602. Optionally, this information is integrated into various enterprise systems such as WMS, SCM and ERP 617.

FIG. 7 illustrates a high level diagram of single LS, such as LS 601a, from the plurality of LSs 601a through 601d. Disposed within the LS are the array of RF antennas 401, RF processing circuitry 402, digital signal processing (DSP) circuitry 703, an 802.11x MAC 704 and an 802.11x front end 705. The 802.11x MAC 704 and an 802.11x Front end 705 are for wirelessly communicating of triangulation information to the AP 603.

Optionally, as shown in FIG. 8, when there is no existing 802.11x wireless network infrastructure that has an AP. The plurality of LSs, 801a through 801d, are each adapted, as required, for operating as an AP for wireless devices, 802 and 803, that are used within the network 800. Advantageously, there is no need to install an 802.11x network infrastructure prior to the installation of the WTS 800. The WTS server 602 communicates with each of the LSs, 801a through 801d and performs both wireless tracking operations as well as executes the specialized API to allow it to interface with any number of application-specific systems or software programs, such as Internet access, database management systems and security applications, similar to that illustrated in FIG. 6b.

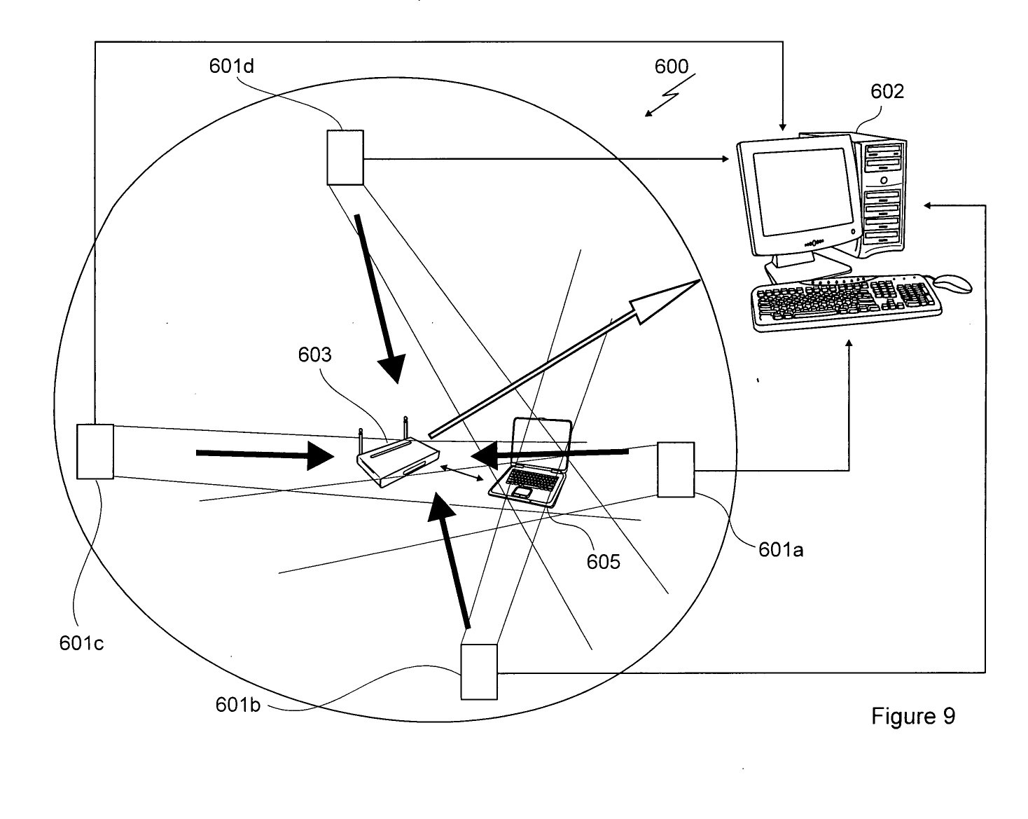

FIG. 9 illustrates the WTS 600 for not only tracking of a MT but also for use in location determination of a wireless device 605, such as laptop computer having 802.11x wireless capabilities.

Referring back to FIG. 6a, in operation of the MT 300, the MT 300 broadcasts a secure data packet when at least one of the following two conditions are satisfied: when it is being polled by the WTS server 602, or when it senses a motion that is within preprogrammed parameters. The AP 603 verifies the transmission as being a genuine and recognizes the MT 300 as a registered wireless device within the WTS 600 and triggers the WTS server 602 to initialize a location triangulation procedure. Each LS, 601a thorough 601d, triangulates the angle of arrival of the wireless signal emitted for the MT 300 and then transfers the location parameters wirelessly to the AP 603. This information is then passed on to the WTS server 602, which performs a system-level location triangulation using statistical methods.

Advantageously, the embodiments of the invention allow for accurately triangulating and displaying the location of any WiFi device and any MT in an indoor or a localized outdoor environment.

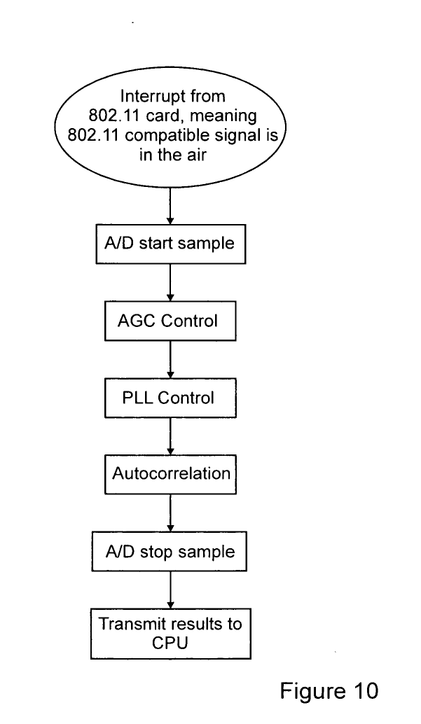

A person of skill in the art will appreciate that there are a variety of ways of measuring angle of arrival information that a system according to the invention will support. Referring to FIG. 4b output signals are provided to a digital signal processor in the form of a floating point gate array (FPGA). The FPGA runs three major methods and controls the A/D with start-sample/stop-sample. Referring to FIG. 10 (OK FIG. 4) a flow chart illustrates a suggested FPGA method flow that supports a wide variety of embodiments of the invention.

The FPGA method flow begins after receiving an interrupt from the 802.11 card which means that 802.11 compatible signal is detected in the air in the respective channel. The FPGA then sends a start-sample signal to the analog to digital converter (A/D), and receives sampled data from the A/D. When the FPGA starts receiving the sampled data from the A/D the FPGA starts an Automatic Gain Control (AGC) method. The AGC method monitors the signal coming from the A/D, and controls the gain of the amplifiers in the RF part of the LS, so that maximum range of the A/D is utilized without over amplifying the RF signal, and thereby avoiding saturation of the A/D.

Once the AGC method settles, and the gain of the amplifier is set to be constant, the FPGA initializes the phase locked loop (PLL) control method. The PLL control method is necessary in order to avoid a beat frequency phenomenon. A beat frequency phenomenon occurs when transmitter and receiver LO (Local Oscillator) frequencies are not perfectly synchronized. In a case using the 802.11 protocol, the 802.11standard specifies that 802.11 devices' LO frequency tolerances are +−60 kHz. In order to minimize this effect if it is present the FPGA runs the PLL control method, which monitors the incoming signal coming from the A/D, calculates the frequency offset between transmitter and receiver LO, and adjusts the receiver PLL so that it more closely matches the transmitter LO. The FPGA runs the correlation method that correlates the data coming from the A/D and sends it to the CPU.

A wide variety of methods are available for computing the angle of arrival. For example, Ziskind and M. Wax, “Maximum Likelihood Localization of Multiple Sources by Alternating Projection,” IEEE Transactions on Acoustics, Speech, and Signal Processing, Vol. 36, NO. 10, October 1988 (Ziskind) is considered to be suitable for this purpose. This method minimizes the computational requirement of the LS or the WTS server. The tradeoff for minimized computational complexity is accuracy. It should be noted that a receiver will likely receive wireless signal that arrive at the receiver after bouncing off a surface that is not normally associated with wireless transmitter. Such reflected signals should correspond to a local maximum signal intensity but not a global maximum of signal intensity. When a local maximum is confused with a global maximum then an incorrect angle of arrival measurement is likely to be provided.

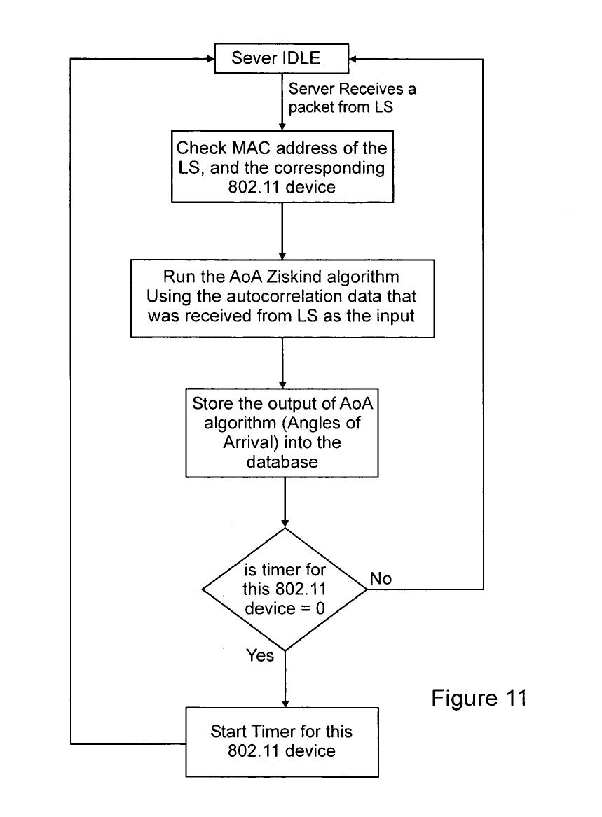

Referring to FIG. 11, a flowchart showing a suggested operation flow of the WTS server is shown. The WTS Server sits in an idle state in which it awaits data transmissions coming from the LS. Once it receives a packet from the LS, the server obtains the MAC addresses of the LS, and the 802.11 device which corresponds to LS′ autocorrelation data. The server then runs the Ziskind AoA method, and provides the output of the method, the computed angles of arrival corresponding with N−1 strongest rays, to a database where N is the number of antenna elements in the antenna of the LS. The server then checks the timer corresponding to the MAC address of the 802.11 device in question. If the timer is indicated as being zero, corresponding to first transmission by first LS concerning the particular 802.11 device, the server starts a timer that is associated with the 802.11 device in question, and returns to idle state. If the timer has already been started, the server returns to idle state.

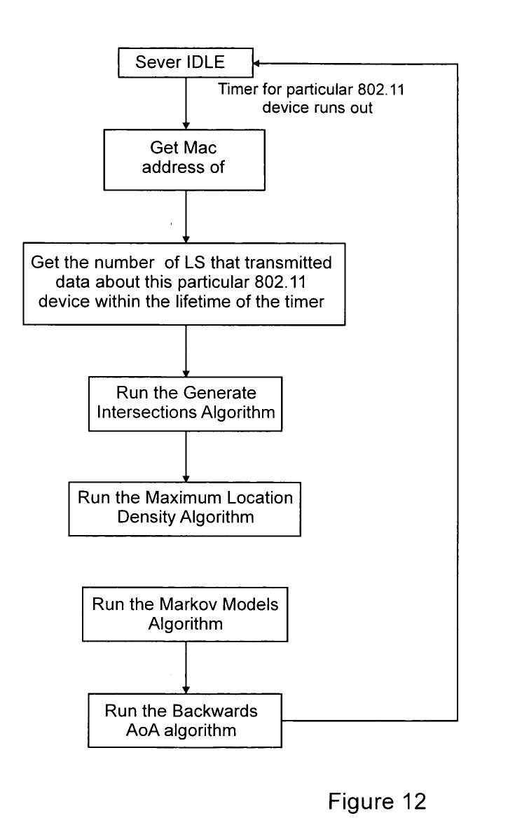

Referring to the flow chart of FIG. 12, the recommended operations carried out in response to a timer running out are shown. As illustrated in FIG. 12, once the timer for a particular 802.11 device runs out, the WTS server retrieves the MAC address of the device whose timer ran out, as well as the number of LS that transmitted autocorrelation data about the 802.11 device in question. Using this number of LS and the relevant calculated AoA (Angles of Arrival) as input the server runs methods to: generate intersections, determine maximum location density, apply the Markov model and apply the backwards AoA measurement respectively. An exception to this is in the instance when a lower than the minimum number of LS transmitted information associated with a particular MAC. Once the WTS server completes these methods it returns to state IDLE.

Generate Intersections

The method used to generate intersections receives data corresponding to:
Number of sensors that picked up the transmission N
Location of each LS (x,y)
Orientation of each sensor
Angles of arrivals received from each sensor AoA

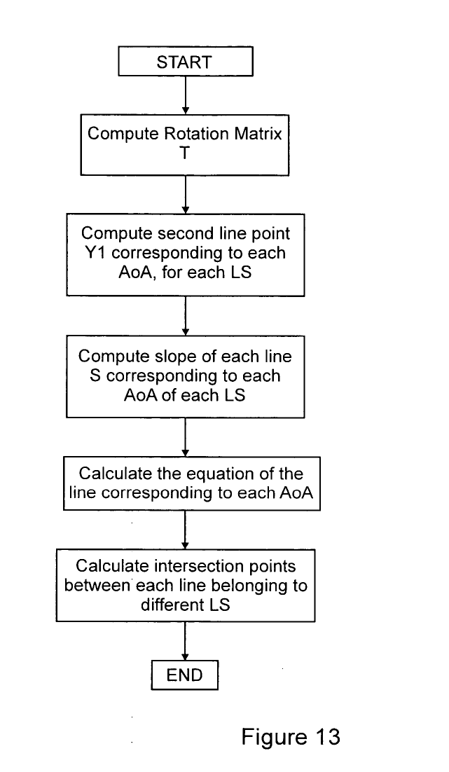

Referring to FIG. 13, a suggested sequence of calculations that generate intersections follows is shown. The rotation matrix is given by:

$${T}_{i} = [ \begin{matrix}cos ( \frac{{rot}_{i} π}{180} ) & - sin ( \frac{{rot}_{i} π}{180} ) \\ sin ( \frac{{rot}_{i} π}{180} ) & cos ( \frac{{rot}_{i} π}{180} )\end{matrix} ]$$

A second point of the line is calculated according to the following formula:

$${y}_{1} ( i , j , \text{:} ) = [ LS ( i , 1 ) + cos ( \frac{AoA ( i , j ) π}{180} ) , \\ LS ( i , 2 ) + sin ( \frac{AoA ( i , j ) π}{180} ) ] {T}_{i}$$

Where
i=N, and j=q,
Where
q=Number of resolved rays

Then the slope of the line is calculated as follows:
ti if (y₁(i,j,1)≧LS(i,1))

$$S ( i , j ) = ( \frac{{y}_{1} ( i , j , 2 ) - LS ( i , 2 )}{{y}_{1} ( i , j , 1 ) - LS ( i , 1 )} )$$

else

$$S ( i , j ) = ( \frac{- {y}_{1} ( i , j , 2 ) + LS ( i , 2 )}{- {y}_{1} ( i , j , 2 ) + LS ( i , 1 )} )$$

Where [symbol] Slope of the line
And the equation of each line is calculated as follows
L_{i,j}(x)=S(i,j)(x−LS(i,1))+LS(i,2)
Where
x [symbol] x−axis of coverage area

The intersection points “guesses” are calculated as follows:

$$X ( i , j ) = {min}_{x} ( ‖ {L}_{ij} - {L}_{kl} ‖ )$$

Where
i,k=1:N, and j,l=1:q
guess(i,j)=[X(i,j), Lᵢⱼ(X(i,j))]
where
size of of guess=[N(2(N−1)),2]
The entries of the guess matrix are rounded to the nearest “grid size.” “Grid size,” and the reason for rounding are described hereinbelow.

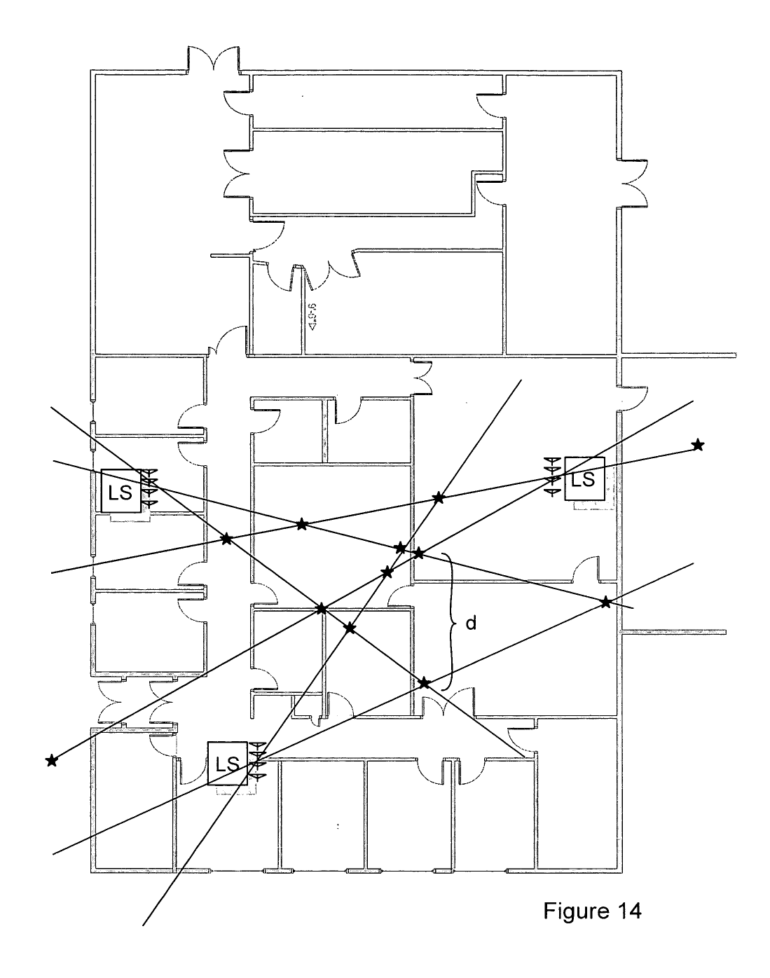

The output data from generate intersections is a matrix containing the (x,y) pairs of each intersection of each line from each sensor. Generate intersections provides possible location points of the 802.11 device in question. Referring to FIG. 14, a diagram representative of the output of generate intersections is shown superimposed over a floorplan.

The Maximum Location Density Method

The maximum location density method receives as input data possible physical location coordinates provided by generate intersections, and computes the probability of being correct for each possible (x,y) location pair. The maximum location density method assumes that possible location pairs, that are part of dense clusters of a group of guesses are more probable locations of the 802.11 device in question then guesses that are far from all of the other guesses.

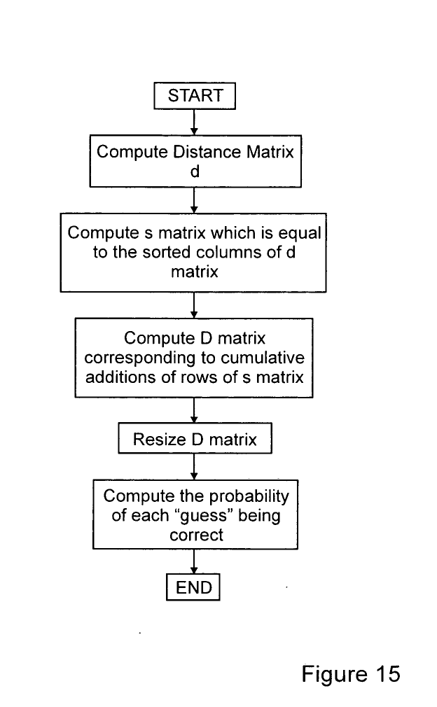

Referring to FIG. 15, a flowchart indicative of a maximum location density method is shown.

Initially the distances between each point and all of the other points is computed and stored into the matrix d.

$$d ( m , n ) = \sqrt{{( guess ( m , 1 ) - guess ( n , 1 ) )}^{2} + {( guess ( m , 2 ) - guess ( n , 2 ) )}^{2}}$$

Where
m, n=1, 2, 3, . . . , N(2(N−1))

The physical meaning of d(m,n) is shown in FIG. 14. The columns of d are then sorted in ascending order in the following way.
s(m,:)=sort(d(m,:)

The s matrix is the same size as d matrix, namely N(2(N−1)) by N(2(N−1)). The D matrix is computed by cumulatively adding the columns of s matrix in the following way:

$$D = [ \begin{matrix}{s}_{1 , 1} & {s}_{1 , 1} + {s}_{1 , 2} & … & {s}_{1 , 1} + {s}_{1 , 2} + {s}_{1 , 3} + … + {s}_{1 , C} \\ {s}_{2 , 1} & {s}_{2 , 1} + {s}_{2 , 2} & … & {s}_{2 , 1} + {s}_{2 , 2} + {s}_{2 , 3} + … + {s}_{2 , C} \\ ⋮ & ⋮ & ⋰ & ⋮ \\ {s}_{C , 1} & {s}_{C , 1} + {s}_{C , 2} & … & {s}_{C , 1} + {s}_{C , 2} + {s}_{C , 3} + … + {s}_{C , C}\end{matrix} ]$$

Where C=N(2(N−1)) The matrix D is resized so that,

$$\overline{D} = [ \begin{matrix}{D}_{1 , 1} & {D}_{1 , 2} & … & {D}_{1 , N} \\ {D}_{2 , 1} & {D}_{2 , 2} & … & {D}_{2 , N} \\ ⋮ & ⋮ & ⋰ & ⋮ \\ {D}_{C , 1} & {D}_{C , 2} & … & {D}_{C , N}\end{matrix} ]$$

so that D is a C by N matrix

The probabilities of each intersection “guess” being accurate are calculated as follows.

$${p}_{u , v} = \frac{\frac{1}{{\overline{D}}_{u , v}}}{{\sum }_{g = 2}^{N} \frac{1}{{\overline{D}}_{g , v}}}$$

Where p is the probability matrix and,
P_{u,v} [symbol] (guess(u,:)=correct location/v−1 sensors resolved a direct ray)

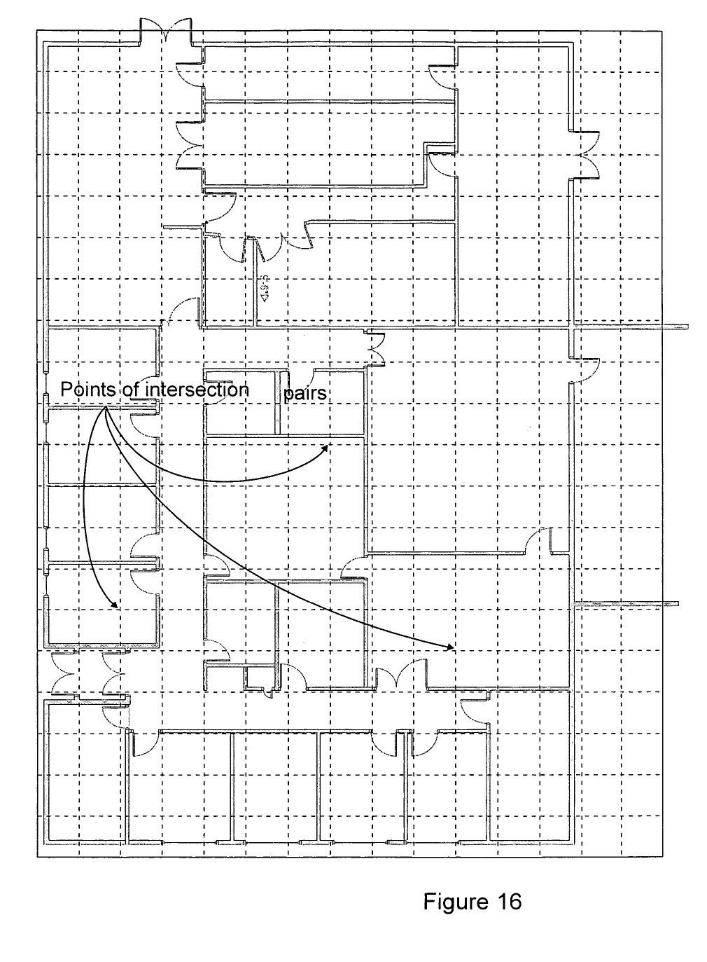

Thus, the probability matrix provides an estimate that guess(u,: ) is the correct location of the 802.11 device in question, given that v−1 sensors resolved a direct ray. Referring to FIG. 16, a diagram of a floor plan is superimposed with a grid and points corresponding to likely locations of a wireless device as determined by the maximum location density method.

Markov Model Method

The two previous methods, AoA method, generate intersection, and maximum location density methods all manipulate data and compute results associated with the current—latest—information that is received from the LS. The Markov Model method recognizes that past, or previous patterns and results can be used together with the previously described methods to provide a more accurate result. By noting that the 802.11 devices are being tracked in real-time, the Markov Model method assumes that devices move “smoothly,” and continuously from one point on to another within a facility.

By rounding all of “continuous” intersection pairs to the nearest grid intersection point,

x₀=round(x)

y₀=round(y)

only the intersection points (xₒ,y₀) of the grid likely marks a possible location of the device. This is in effect quantizing of the possible points of location. Then, an infinite number of possible x,y locations is limited to a finite number, depending on the size of the required grid. Each set of points (xₒ,y₀) is viewed as a state, within a Markov Model, and only transitions between adjacent states are possible, in other words wireless devices move continuously, and “smoothly.” Thus,
p[xₜ=xᵢ,yₜ=yᵢ|xₜ₋₁=xⱼ,yₜ₋₁=yⱼ]=0 if |xⱼ−xᵢ|>g or |yⱼ−yᵢ|>g
and

$${\sum }_{ij} p [ {x}_{t} = {x}_{i} , {y}_{t} = {y}_{i} \vert {x}_{t - 1} = {x}_{j} , {y}_{t - 1} = {y}_{j} ] = 1$$

where:
xₜ [symbol] quantized x coordinate at time t
yₜ [symbol] quantized y coordinate at time t
g [symbol] grid spacing
p[xₜ=xᵢ,yₜ=yᵢ|xₜ₋₁=xⱼ,yₜ₋₁=yⱼ] [symbol] probability
that at time t, x coordinate=xᵢ and y coordinate=yᵢ, given that at time t−1, x coordinate=xⱼ and y coordinate=yⱼ

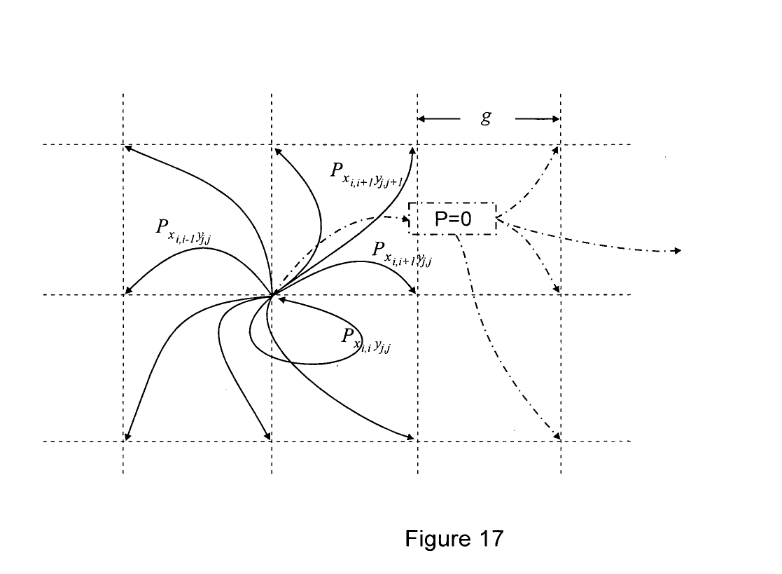

Referring FIG. 17, those transitions between adjacent states consistent with the Markov Model are shown. FIG. 17 also shows that transitions between different states need not have different probabilities. That is, it may be more likely to go from state Y to state X, rather than from state Y to state Z. This could be due to a number of reasons, one of which might be barriers, such as walls. In other words, the Markov model method has the ability to model stochastic barriers, such as walls, by calculating the probabilities of transitions between adjacent states. If transition between states Y and Z occurs very rarely, the Markov model probability of the transition will be close to zero, whereas if the probability between state X and Y occurs often then that probability will be “high” close to one in the Markov model. These assumptions are based on parameters used for a class of examples and can be modified to improve performance in different environments and needs without substantially changing the method itself.

These Markov transitions probabilities are used to assist previous methods choose the most likely location of the wireless device. The transition probabilities are in effect used as weights to weigh the probabilities calculated with the previous methods.

The wireless device in the FIG. 17 that is located at points (xₒ,yₒ) has only nine possible states to move to on the next measurement. These states correspond to eight adjacent states, and one possibility to remain in the same state. For each state the Markov Model method maintains transition probabilities to all adjacent states. Then the state probability matrix M is:

$$M = [ \begin{matrix}{p}_{{x}_{1 , 2} {y}_{1 , 1}} & {p}_{{x}_{1 , 2} {y}_{1 , 2}} & {p}_{{x}_{1 , 1} {y}_{1 , 2}} & {p}_{{x}_{1 , 0} {y}_{1 , 2}} & {p}_{{x}_{1 , 0} {y}_{1 , 1}} & {p}_{{x}_{1 , 0} {y}_{1 , 0}} & {p}_{{x}_{1 , 1} {y}_{1 , 0}} & {p}_{{x}_{1 , 2} {y}_{1 , 0}} & {p}_{{x}_{1 , 1} {y}_{1 , 1}} \\ {p}_{{x}_{2 , 3} {y}_{2 , 2}} & {p}_{{x}_{2 , 3} {y}_{2 , 3}} & {p}_{{x}_{2 , 2} {y}_{2 , 3}} & {p}_{{x}_{2 , 1} {y}_{2 , 3}} & {p}_{{x}_{2 , 1} {y}_{2 , 2}} & {p}_{{x}_{2 , 1} {y}_{2 , 1}} & {p}_{{x}_{2 , 2} {y}_{2 , 1}} & {p}_{{x}_{2 , 3} {y}_{2 , 1}} & {p}_{{x}_{2 , 2} {y}_{2 , 2}} \\ ⋮ & ⋮ & ⋮ & ⋮ & ⋮ & ⋮ & ⋮ & ⋮ & ⋮ \\ {p}_{{x}_{B , B + 1} {y}_{D , D}} & {p}_{{x}_{B , B + 1} {y}_{D , D + 1}} & {p}_{{x}_{B , B} {y}_{D , D + 1}} & {p}_{{x}_{B , B - 1} {y}_{D , D + 1}} & {p}_{{x}_{B , B - 1} {y}_{D , D}} & {p}_{{x}_{B , B - 1} {y}_{D , D - 1}} & {p}_{{x}_{B , B} {y}_{D , D - 1}} & {p}_{{x}_{B , B - 1} {y}_{D , D - 1}} & {p}_{{x}_{B , B} {y}_{D , D}}\end{matrix} ]$$

$$Where B = \frac{\vert max ( x ) - min ( x ) \vert}{g} , and D = \frac{\vert max ( y ) - min ( y ) \vert}{g}$$

and g [symbol] grid spacing
and size of M matrix is BD by 9
and pₓ_{_{i,i+t}}_{yj,j+1}=p[xₜ=xᵢ₊₁,yₜ=yⱼ₊₁|xₜ₋₁=xᵢ, yₜ₋₁=yⱼ]
where, max(x) is the maximum of x coordinate and min(x) is the min of x coordinate, and max(y) is the maximum of y coordinate, and min(y) is the minimum of y coordinate respectively.

Matrix M can be written as:

$$M = [ \begin{matrix}{M}_{1} \\ {M}_{2} \\ ⋮ \\ {M}_{BD}\end{matrix} ]$$

Where M is the i'th row of matrix M, and

$${\sum }_{j = 0}^{8} {M}_{i} ( j ) = 1$$

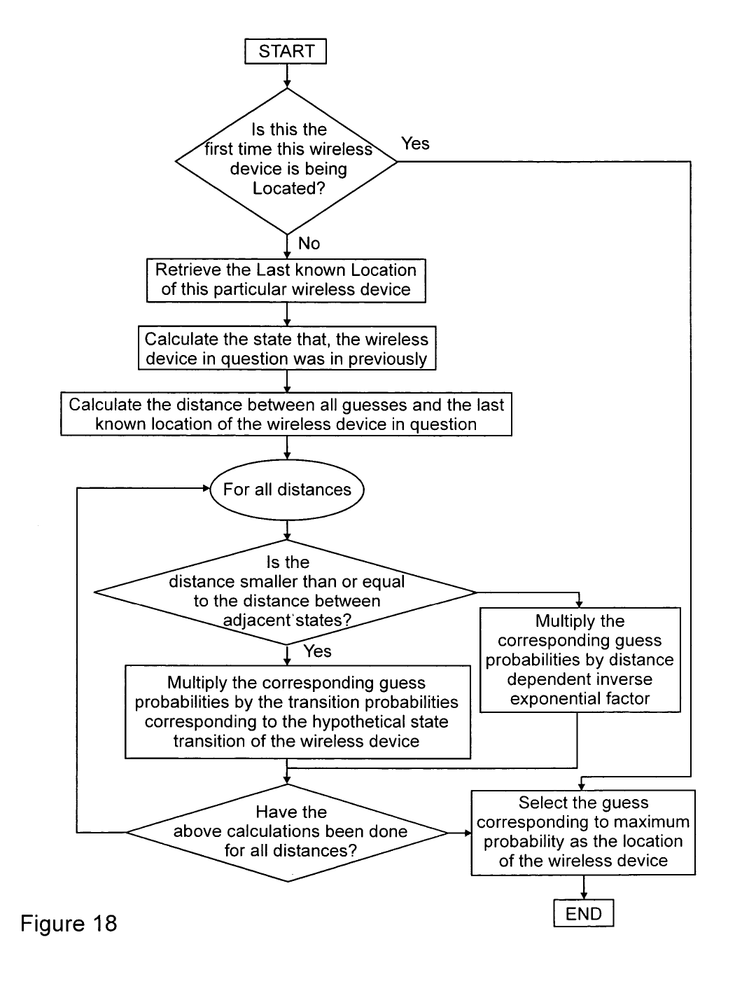

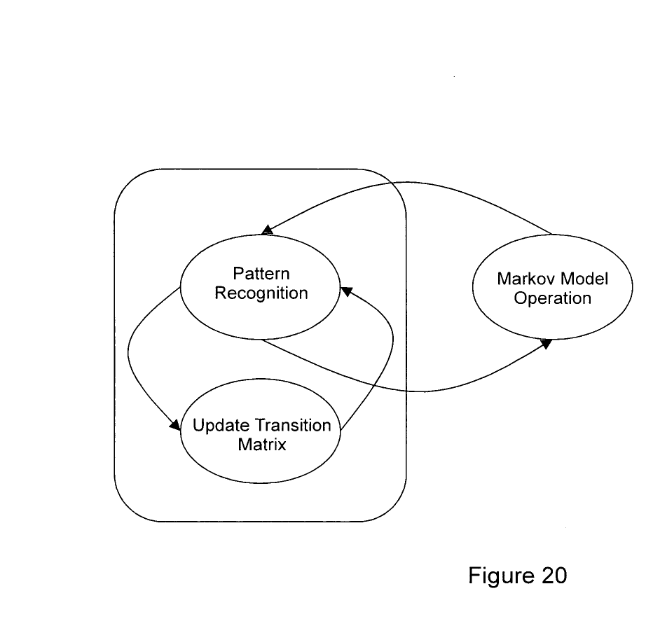

Referring to FIG. 18, a flow chart that illustrates the operation of the Markov Model method is shown. The distances between all of the guesses, and the last known locations are calculated in the following fashion.

$$dist [ \begin{matrix}\sqrt{{( guess ( 1 , 1 ) - {x}_{t - 1} )}^{2} + {( guess ( 1 , 2 ) - {y}_{t - 1} )}^{2}} \\ \sqrt{{( guess ( 2 , 1 ) - {x}_{t - 1} )}^{2} + {( guess ( 2 , 2 ) - {y}_{t - 1} )}^{2}} \\ ⋮ \\ \sqrt{{( guess ( N ( 2 ( N - 1 ) ) , 1 ) - {x}_{t - 1} )}^{2} + {( guess ( N ( 2 ( N - 1 ) ) , 2 ) - {y}_{t - 1} )}^{2}}\end{matrix} ]$$

Where xₜ₋₁, and yₜ₋₁ are last x and y coordinates, respectively of the 802.11 device in question. Then as shown in the flow chart of FIG. 20, for all distances the probabilities computed by the previous methods are weighed in the following fashion.

index = yₜ₋₁(w) + yₜ₋₁
for i = 1:2N(N − 1)
for j = 1:q

if(dist(i) ≦ g)

if(guess(i,:) = [xₜ₋₁ + 1,yₜ₋₁])

Pᵢ = max(p(i,j)M_{index} (1))

if(guess(i,:) = [xₜ₋₁ + 1,yₜ₋₁ + 1])

Pᵢ = max(p(i,j)M_{index} (2))

if(guess(i,:) = [xₜ₋₁,yₜ₋₁ + 1])

Pᵢ = max(p(i,j)M_{index} (3))

if(guess(i,:) = [xₜ₋₁ − 1,yₜ₋₁ + 1])

Pᵢ = max(p(i,j)M_{index} (4))

if(guess(i,:) = [xₜ₋₁ − 1,yₜ₋₁])

Pᵢ = max(p(i,j)M_{index} (5))

if(guess(i,:) = [xₜ₋₁ − 1,yₜ₋₁ − 1])

Pᵢ = max(p(i,j)M_{index} (6))

if(guess(i,:) = [xₜ₋₁,yₜ₋₁ − 1])

Pᵢ = max(p(i,j)M_{index} (7))

if(guess(i,:) = [xₜ₋₁ + 1,yₜ₋₁ − 1])

Pᵢ = max(p(i,j)M_{index} (8))

if(guess(i,:) = [xₜ₋₁,yₜ₋₁])

Pᵢ = max(p(i,j)M_{index} (9))

else

Pᵢ = max(p(i,j)e^{-dist(i)})

Then the final guess of the calculation is chosen from the “guess” matrix, as an entry corresponding to the largest entry in the P matrix.
[Value Index]=max(P)
Final Guess=guess(index,:)
Markov Model Training Procedure

In order to provide useful data, the Markov model should be provided relevant and accurate transition probabilities. Those probabilities are “learned” throughout the operation of the system through “training” of the Markov model. Typically, training of Markov models is performed by providing the model with a known input, measuring the output of the models, and then changing of the transition probabilities in order to correct any error discrepancies between the known input and the output of the model. This procedure is repeated a number of times for all possible outcomes. In addition, in the case of a time varying problem, such as location of wireless devices, which is time varying because the wireless channel is time varying, the entire procedure has to be repeated at periodic intervals in time. This would involve a person walking around with a handheld wireless device, noting down all of the state changes—changes of location—and then using them to train the model. In order to avoid manual training of the model, an automatic training method and model is disclosed hereinbelow.

Automatic Training

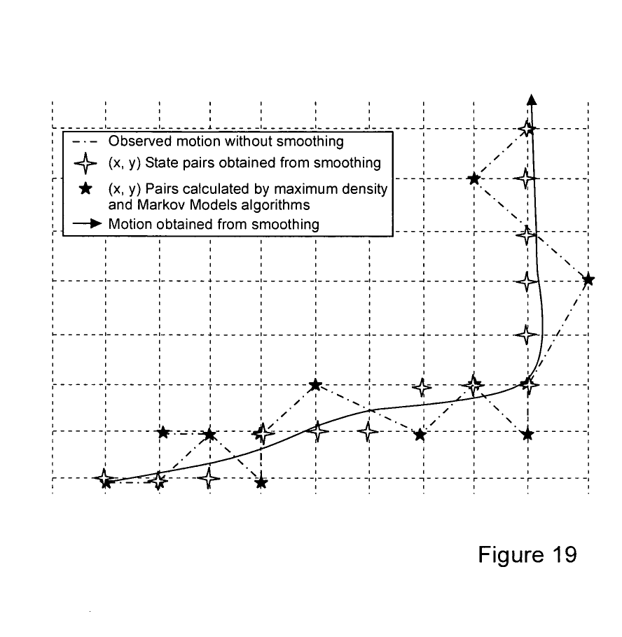

Automatic training allows the Markov Model to train itself seamlessly without a need for manual training. If there are sufficient location observations, a general pattern of motion of a wireless device is recognizable. In other words simple filtering, moving average, LS, RLS and other gradient-based methods, or pattern recognition methods provide a general past direction of movement, as shown in FIG. 19. Therefore, by assuming that wireless devices move “continuously,” and only transitions between adjacent coordinates are possible, it is possible to compute general direction of movement of a device in question, even if some measurements are incorrect or are imprecise, as shown in FIG. 19.

Therefore, by processing past observations, a system determines a more probable series of state transitions of the wireless device. This reprocessed, or smoothed, series of transitions shown as stars in FIG. 14 are then used to “train,” or update the Markov Models transition probabilities, as follows.

If transition from state (xᵢ,yⱼ) to state (xᵢ₊₁,yⱼ) was determined to have occurred, then the Markov Model transition probabilities change as follows:

$${M}_{n} = \frac{⌊ \begin{matrix}{p}_{{x}_{i , i + 1} {y}_{j , j}} + 1 & {p}_{{x}_{i , i + 1} {y}_{j , j + 1}} & {p}_{{x}_{i , i} {y}_{j , j + 1}} & {p}_{{x}_{i , i - 1} {y}_{j , j + 1}} & {p}_{{x}_{i , i - 1} {y}_{j , j}} & {p}_{{x}_{i , i - 1} {y}_{j , j - 1}} & {p}_{{x}_{i , i} {y}_{j , j\_ 1}} & {p}_{{x}_{i , i + 1} {y}_{j , j - 1}} & {p}_{{x}_{i , i} {y}_{j , j}}\end{matrix} ⌋}{( 2 )}$$

where Mₙ is the n'th row of transition probability matrix M. Where n is the row associated with state (xᵢ,yⱼ) .

Within the operation of the system, the Markov Model method switches between operation state and training state, as shown in FIG. 20. The method repeats automatic training periodically with an arbitrary period or alternatively, with a fixed period. Alternatively, the training is initiated at intervals that are known or further alternatively are somewhat random, pseudo random, or truly random. Further alternatively, the intervals are marked by an event such as a user initiation event, an audit event, a number of location determination events, and so forth. At that time, as shown in the FIG. 20, the Markov Model method executes a moving average pattern recognition of past movements of all tags, and updates the transition probabilities as shown in the equation above, and FIG. 19. This method when generalized, is applicable to an arbitrary number of different devices.

Backwards AoA Method

The backwards AoA method is executed after the Markov Model method as shown in the flow chart of FIG. 12. The backwards AoA method receives a calculated (x,y) location of the wireless device from the Markov Model method, as well as the locations of all of the LS and their orientation. The Backwards AoA method calculates the AoA (Angle of Arrival) each LS would have if the location calculation provided by the Markov Models is accurate. In that respect, Backwards AoA method is somewhat of an opposite of generate intersections.

If (x₀,y₀) is the location calculated by the Markov Model method, LS is a 2 by N matrix containing the (x,y) coordinates of the location sensors, and rot is a 1 by N matrix containing bearing in degrees of each LS, the Backwards AoA Method calculates the AoA that each LS should provide if the location (x₀,y₀) is indeed correct. This is calculated as follows.

$${A}_{i} = \pm {tan}^{- 1} ( \frac{LS ( i , 1 ) - {x}_{0}}{LS ( i , 2 ) - {y}_{0}} ) = {rot}_{i}$$

where
i=1, 2, 3,. . . N and N is the number of sensors.

This result is stored into the memory of the WTS Server, along with the MAC address of the 802.11 device in question, which is being located. That way, when that particular 802.11 device transmits subsequently the input data to the Ziskind AoA method are the calculated Aᵢ's. The calculated Aᵢ's above are used as first approximations in the Ziskind AoA method.

Such a method allows for estimation and validation of estimation results allowing for both iterative approaches to solutions that may or may not have unique results and a verification process to indicate those results that are likely accurate. As such, the method is applicable not merely to identifying a location of a theoretical single tag in a noise free environment, but to real world identification of tag locations of many tags within a noisy environment.

Numerous other embodiments may be envisaged without departing from the spirit or scope of the invention.

1. A method for estimating a location of one of a plurality of wireless devices that transmit a plurality of data packets within a wireless tracking system comprising:
providing a plurality of location sensors comprising a plurality of antenna elements;
receiving the plurality of data packets using the plurality of antenna elements, each data packet in accordance with an 802.xx compatible data transmission protocol for use in wireless data communication, where each of the plurality of antenna elements receives the plurality of data packets with a different delay time therebetween;
determining an angle of arrival at each location sensor from the plurality of location sensors in dependence upon the different delay time between the received data packets to form a plurality of angles of arrival;
measuring at each of the plurality of antenna elements an intensity of the received plurality of data packets to form a plurality of intensities;
providing the plurality of angles of arrival and the plurality of intensities to a wireless tracking system server; and,
estimating a location of the wireless device within the wireless tracking system in dependence upon the plurality of angles of arrival and the plurality of intensities from each of the plurality of location sensors using the wireless tracking system server.

2. A method according to claim 1, wherein the angle of arrival is determined for each location sensor from the received data packets having different delay times for each of the plurality of antenna elements.

3. A method according to claim 1, where the plurality of location sensors are unsynchronized with one another and are spatially separated from each other, wherein the location of said wireless device is such that it's signal is receivable by least two of the location sensors from the plurality of location sensors.

4. A method according to claim 1, wherein the location sensors are for monitoring of the plurality of data packets being transmitted in the wireless tacking network.

5. A method according to claim 1, wherein in receiving the plurality of data packets using the plurality of antenna elements, a preamble-header portion of the data packet is used.

6. A method according to claim 1, comprising accumulating a plurality of data packets at each of the location sensors for performing statistical and historical averaging using the wireless tracking system server.

7. A method according to claim 1, wherein the plurality of intensities are used for adaptively optimizing a sampling threshold for each location sensor.

8. A method according to claim 1, wherein the plurality of angles of arrival and the plurality of intensities are provided to the wireless tracking network server using an Ethernet connection.

9. A method according to claim 1, wherein the plurality of angles of arrival and the plurality of intensities are provided to the wireless tracking network server using a known wireless data transmission protocol.

10. A method according to claim 1, wherein determining an angle of arrival at each location sensor comprises applying a Ziskind method to determine the angle of arrival.

11. A method according to claim 1, wherein estimating a location of the wireless device comprises:
determining a set of likely intersections in dependence upon the determined angle of arrival for each location sensor and data corresponding to a known physical position of for each location sensor.

12. A method according to claim 11, wherein estimating a location of the wireless device comprises:
estimating a probability of a given intersection corresponding to a correct location of a transmitter of the plurality of data packets.

13. A method according to claim 12, wherein estimating a location of the wireless device comprises:
storing previously determined location data corresponding to a past determined location of the transmitter; and,
applying a Markov model based on intersection data, probability data and previously determined location data to determine a new location of the transmitter.

14. A method according to claim 13, wherein estimating a location of the wireless device comprises:
applying a backwards angle of arrival method to determine the angle of arrival based upon the determined new location of the transmitter.

15. A method for estimating a location of one of a plurality of wireless devices that transmit a plurality of data packets within a wireless tracking system comprising:
providing a plurality of location sensors comprising a plurality of antenna elements;
receiving the plurality of data packets using the plurality of antenna elements, each data packet in accordance with a data transmission protocol for use in wireless data communication, where each of the plurality of antenna elements receives the plurality of data packets with a different delay time therebetween;
determining an angle of arrival at each location sensor from the plurality of location sensors in dependence upon the different delay time between the received data packets to form a plurality of angles of arrival;
measuring at each of the plurality of antenna elements an intensity of the received plurality of data packets to form a plurality of intensities;
providing the plurality of angles of arrival and the plurality of intensities to a wireless tracking system server; and,
estimating a location of the wireless device within the wireless tracking system in dependence upon the plurality of angles of arrival and the plurality of intensities from each of the plurality of location sensors using the wireless tracking system server.

16. A method according to claim 15, where the plurality of location sensors are unsynchronized with one another and are spatially separated from each other, wherein the location of said wireless device is such that it's signal is receivable by least two of the location sensors from the plurality of location sensors.

17. A method according to claim 15, wherein in receiving the plurality of data packets using the plurality of antenna elements, a preamble-header portion of the data packet is used.

18. A method according to claim 15, comprising accumulating a plurality of data packets at each of the location sensors for performing statistical and historical averaging using the wireless tracking system server.

19. A method according to claim 15, wherein the plurality of intensities are used for adaptively optimizing a sampling threshold for each location sensor.

20. A method according to claim 15, wherein the plurality of angles of arrival and the plurality of intensities are provided to the wireless tracking network server using an Ethernet connection.

21. A method according to claim 15, wherein determining an angle of arrival at each location sensor comprises applying a Ziskind method to determine the angle of arrival.

22. A method according to claim 15, wherein estimating a location of the wireless device comprises:
determining a set of likely intersections in dependence upon the determined angle of arrival for each location sensor and data corresponding to a known physical position of for each location sensor.

23. A method according to claim 22, wherein estimating a location of the wireless device comprises:
estimating a probability of a given intersection corresponding to a correct location of a transmitter of the plurality of data packets.

24. A method according to claim 23, wherein estimating a location of the wireless device comprises:
storing previously determined location data corresponding to a past determined location of the transmitter; and,
applying a Markov model based on intersection data, probability data and previously determined location data to determine a new location of the transmitter.

25. A method according to claim 24, wherein estimating a location of the wireless device comprises:
applying a backwards angle of arrival method to determine the angle of arrival based upon the determined new location of the transmitter.

26. A system for using a wireless network wireless communication protocols comprising:
a plurality of mobile tags for communicating with the wireless tracking system using data transmission signals and for receiving data from the wireless network in accordance with 802.xx compatible communication protocols;
a plurality of location sensors spatially disposed from one another, each location sensor comprising a plurality of antenna elements for passively receiving the data transmission signals transmitted from the mobile tag and in accordance with a known data transmission protocol for wireless data communication and a processor for determining a time difference of arrival between the plurality of antenna elements and for in dependence upon the determined time difference of arrival calculating an angle of arrival of said data transmission signals from the mobile tag and for determining an intensity of said data transmission signals; and,
a central processing system for receiving the angle of arrival and the intensity of said data transmission signals for each of the plurality of location sensors and for performing statistical calculations to estimate a physical location of the mobile tag in relation to the plurality of location sensors.

27. A system according to claim 26, wherein the central processing system communicates each of the plurality of location sensors using a known data transmission protocol for wireless data communication.

28. A system according to claim 26, wherein the central processing system communicates each of the plurality of location sensors using one of an Ethernet and WLAN connection therebetween.

29. A system according to claim 26, wherein each location sensor comprises a transmitter for transmitting data from the wireless network in accordance with the wireless communication protocols to each of the plurality of mobile tags.

30. A receiver for use with a wireless tracking system comprising:
a plurality of antenna elements for receiving 802.xx compatible wireless data communication signals according to a predetermined protocol;
a processor for identifying a data packet within a signal and based on protocol data therein, for determining an angle of arrival of the data packet based on differences in signal received at each of the plurality of antenna elements and for determining an intensity of the signal including the data packet; and,
a transmitter for transmitting the angle of arrival and the determined intensity of the signal to a wireless tracking system.

31. A mobile tag comprising:
an accelerometer for sensing a movement of the mobile tag; and,
a wireless transmitter for transmitting data relating to an identification of the mobile tag to a location sensor in accordance with wireless communication protocols upon the piezo sensor sensing movement of the mobile tag.

32. A mobile tag according to claim 31, wherein the accelerometer comprises a piezoelectric sensor.

33. A mobile tag according to claim 31, wherein the wireless communication protocol is an 802.xx wireless communications protocol.

34. A mobile tag according to claim 33, comprising a wireless receiver for receiving data from a WLAN in accordance with the wireless communication protocols.

35. A mobile tag according to claim 33, comprising a memory circuit for storing of data comprising data for encoding of the identification of the mobile tag.

36. A mobile tag according to claim 33, comprising a rechargeable battery module for powering of the transmitter circuit.
